(19) United States
(12) Patent Application Publication
(10) Pub. No.: US 2025/0081282 A1
(43) Pub. Date: Mar. 6, 2025

(54) TECHNIQUES FOR CELL ACTIVE TIME EXTENSION

(71) Applicant: QUALCOMM Incorporated, San Diego, CA (US)

(72) Inventors: Ahmed ELSHAFIE, San Diego, CA (US); Diana MAAMARI, San Diego, CA (US); Huilin XU, Temecula, CA (US); Marwen ZORGUI, San Diego, CA (US); Ahmed Attia ABOTABL, San Diego, CA (US)

(21) Appl. No.: 18/457,991

(22) Filed: Aug. 29, 2023

(51) Int. Cl. H04W 76/28; H04L 5/00; H04W 72/20

(52) U.S. Cl. CPC H04W 76/28; H04L 5/0098; H04W 72/20

(57) ABSTRACT

Methods, systems, and devices for wireless communications are described. A user equipment (UE) may receive control signaling that indicates a cell discontinuous reception (DRX) cycle for a cell communicating with the UE. In some examples, the cell DRX cycle may alternate between an active duration during which the cell may monitor for communications and an inactive duration during which the cell may refrain from monitoring for communications. In some examples, the UE may transmit a request to extend the active duration of the cell DRX cycle during one or more cycles of the cell DRX cycle based on a performance parameter associated with an uplink transmission satisfying a threshold. As such, the UE may transmit the uplink transmission during the active duration of a cycle that is extended based on transmitting the request.

### FIELD OF TECHNOLOGY

The following relates to wireless communications, including techniques for cell active time extension.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for cell active time extension. For example, the described techniques provide for a cell of a network entity to extend an active duration of a cell discontinuous reception (DRX) cycle for one or more units of time. In some cases, the cell may extend the active duration based on a delay tolerance of data for transmission by a user equipment (UE). For example, the UE may transmit a request for the cell to extend the active duration of the cell DRX cycle if the UE is scheduled to transmit a low latency uplink transmission (e.g., data associated with a latency parameter that satisfies a latency threshold). As such, the cell may extend the current active duration or generate an additional active duration, during which the UE may transmit the low latency uplink transmission. In some examples, the cell may semi-statically configure the duration of the extension. In some examples, the UE may dynamically indicate the duration of the extension based on one or more characteristics of the uplink transmission (e.g., a packet size of the uplink transmission, a quality of the uplink channel, or both).

A method for wireless communications by a UE is described. The method may include receiving control signaling that indicates a cell discontinuous reception (DRX) cycle for a cell communicating with the user equipment (UE), the cell DRX cycle alternating between an active duration during which the cell is monitoring for communications and an inactive duration during which the cell refrains from monitoring for communications, transmitting a request to extend the active duration of the cell DRX cycle during one or more cycles of the cell DRX cycle, where transmitting the request is based on a performance parameter associated with an uplink transmission satisfying a threshold, and transmitting the uplink transmission during the active duration of a cycle that is extended based on transmitting the request.

A UE for wireless communications is described. The UE may include one or more memories storing processor executable code, and one or more processors coupled with the one or more memories. The one or more processors may individually or collectively operable to execute the code to cause the UE to receive control signaling that indicates a cell DRX cycle for a cell communicating with the UE, the cell DRX cycle alternating between an active duration during which the cell is monitoring for communications and an inactive duration during which the cell refrains from monitoring for communications, transmit a request to extend the active duration of the cell DRX cycle during one or more cycles of the cell DRX cycle, where transmitting the request is based on a performance parameter associated with an uplink transmission satisfying a threshold, and transmit the uplink transmission during the active duration of a cycle that is extended based on transmitting the request.

Another UE for wireless communications is described. The UE may include means for receiving control signaling that indicates a cell DRX cycle for a cell communicating with the UE, the cell DRX cycle alternating between an active duration during which the cell is monitoring for communications and an inactive duration during which the cell refrains from monitoring for communications, means for transmitting a request to extend the active duration of the cell DRX cycle during one or more cycles of the cell DRX cycle, where transmitting the request is based on a performance parameter associated with an uplink transmission satisfying a threshold, and means for transmitting the uplink transmission during the active duration of a cycle that is extended based on transmitting the request.

A non-transitory computer-readable medium storing code for wireless communications is described. The code may include instructions executable by a processor to receive control signaling that indicates a cell DRX cycle for a cell communicating with the UE, the cell DRX cycle alternating between an active duration during which the cell is monitoring for communications and an inactive duration during which the cell refrains from monitoring for communications, transmit a request to extend the active duration of the cell DRX cycle during one or more cycles of the cell DRX cycle, where transmitting the request is based on a performance parameter associated with an uplink transmission satisfying a threshold, and transmit the uplink transmission during the active duration of a cycle that is extended based on transmitting the request.

Some examples of the method, UEs, and non-transitory computer-readable medium described herein may further include operations, features, means, or instructions for receiving second control signaling that indicates a set of multiple cell DRX modes associated with the cell, where receiving the control signaling includes receiving an indication to activate a first cell DRX mode of the set of multiple cell DRX modes, where the first cell DRX mode includes the DRX cycle.

In some examples of the method, UEs, and non-transitory computer-readable medium described herein, transmitting the request may include operations, features, means, or instructions for transmitting the request at or before a time that may be a duration prior to an end time of a current active duration of the cell DRX cycle.

In some examples of the method, UEs, and non-transitory computer-readable medium described herein, the request may be a buffer status report (BSR) including a quantity of non-zero values and transmitting the request may be based on the quantity of non-zero values satisfying a quantity threshold.

In some examples of the method, UEs, and non-transitory computer-readable medium described herein, and the method, apparatuses, and non-transitory computer-readable medium may include further operations, features, means, or instructions for a first value indicating that the cell may be to maintain the cell DRX cycle, or a second value indicating that the cell may be to extend the active duration.

Some examples of the method, UEs, and non-transitory computer-readable medium described herein may further include operations, features, means, or instructions for identifying a duration of time that the active duration may be to be extended based on transmitting the request.

In some examples of the method, UEs, and non-transitory computer-readable medium described herein, transmitting the request may include operations, features, means, or instructions for transmitting, as part of the request, an indication of a duration of time to extend the active duration.

In some examples of the method, UEs, and non-transitory computer-readable medium described herein, the duration of time may be based on a packet size of the uplink transmission, a reference signal receive power condition of a channel associated with the uplink transmission, or both.

In some examples of the method, UEs, and non-transitory computer-readable medium described herein, a duration of time the active duration may be extended by may be semi-statically configured by the cell.

Some examples of the method, UEs, and non-transitory computer-readable medium described herein may further include operations, features, means, or instructions for receiving second control signaling enabling the UE to request for extensions of the active duration of the cell DRX cycle based on a type of data traffic associated with the UE.

In some examples of the method, UEs, and non-transitory computer-readable medium described herein, the uplink transmission may be a low latency uplink transmission including ultra-reliable low latency communication (URLLC) data or extended reality (XR) data and the performance parameter may be a latency parameter and the threshold may be a latency threshold.

Some examples of the method, UEs, and non-transitory computer-readable medium described herein may further include operations, features, means, or instructions for receiving an acknowledgment message indicating the request to extend the active duration may be successfully received, where transmitting the uplink transmission may be based on receiving the acknowledgment message.

In some examples of the method, UEs, and non-transitory computer-readable medium described herein, the request may be one of a scheduling request (SR) message, a BSR message, uplink control information (UCI), a medium access control-control element (MAC-CE), or a physical uplink control channel (PUCH) including a negative-acknowledgment (NACK).

A method for wireless communications by a cell of a network entity is described. The method may include transmitting control signaling that indicates a cell DRX cycle for the cell communicating with a UE, the cell DRX cycle alternating between an active duration during which the cell is monitoring for communications and an inactive duration during which the cell refrains from monitoring for communications, receiving a request to extend the active duration of the cell DRX cycle during one or more cycles of the cell DRX cycle, where transmitting the request is based on a performance parameter associated with an uplink transmission satisfying a threshold, and receiving the uplink transmission during the active duration of a cycle that is extended based on transmitting the request.

A cell of a network entity for wireless communications is described. The cell of a network entity may include one or more memories storing processor executable code, and one or more processors coupled with the one or more memories. The one or more processors may individually or collectively operable to execute the code to cause the cell of a network entity to transmit control signaling that indicates a cell DRX cycle for the cell communicating with a UE, the cell DRX cycle alternating between an active duration during which the cell is monitoring for communications and an inactive duration during which the cell refrains from monitoring for communications, receive a request to extend the active duration of the cell DRX cycle during one or more cycles of the cell DRX cycle, where transmitting the request is based on a performance parameter associated with an uplink transmission satisfying a threshold, and receive the uplink transmission during the active duration of a cycle that is extended based on transmitting the request.

Another cell of a network entity for wireless communications is described. The cell of a network entity may include means for transmitting control signaling that indicates a cell DRX cycle for the cell communicating with a UE, the cell DRX cycle alternating between an active duration during which the cell is monitoring for communications and an inactive duration during which the cell refrains from monitoring for communications, means for receiving a request to extend the active duration of the cell DRX cycle during one or more cycles of the cell DRX cycle, where transmitting the request is based on a performance parameter associated with an uplink transmission satisfying a threshold, and means for receiving the uplink transmission during the active duration of a cycle that is extended based on transmitting the request.

A non-transitory computer-readable medium storing code for wireless communications is described. The code may include instructions executable by a processor to transmit control signaling that indicates a cell DRX cycle for the cell communicating with a UE, the cell DRX cycle alternating between an active duration during which the cell is monitoring for communications and an inactive duration during which the cell refrains from monitoring for communications, receive a request to extend the active duration of the cell DRX cycle during one or more cycles of the cell DRX cycle, where transmitting the request is based on a performance parameter associated with an uplink transmission satisfying a threshold, and receive the uplink transmission during the active duration of a cycle that is extended based on transmitting the request.

Some examples of the method, cells of a network entity, and non-transitory computer-readable medium described herein may further include operations, features, means, or instructions for transmitting second control signaling that indicates a set of multiple cell DRX modes associated with the cell, where transmitting the control signaling includes transmitting an indication to activate a first cell DRX mode of the set of multiple cell DRX modes, where the first cell DRX mode includes the cell DRX cycle.

In some examples of the method, cells of a network entity, and non-transitory computer-readable medium described herein, receiving the request may include operations, features, means, or instructions for receiving the request at or before a time that may be a duration prior to an end time of a current active duration of the cell DRX cycle.

In some examples of the method, cells of a network entity, and non-transitory computer-readable medium described herein, the request may be a BSR including a quantity of non-zero values and receiving the request may be based on the quantity of non-zero values satisfying a quantity threshold.

In some examples of the method, cells of a network entity, and non-transitory computer-readable medium described herein, and the method, apparatuses, and non-transitory computer-readable medium may include further operations, features, means, or instructions for a first value indicating that the cell may be to maintain the cell DRX cycle, or a second value indicating that the cell may be to extend the active duration.

Some examples of the method, cells of a network entity, and non-transitory computer-readable medium described herein may further include operations, features, means, or instructions for identifying a duration of time that the active duration may be to be extended based on receiving the request.

In some examples of the method, cells of a network entity, and non-transitory computer-readable medium described herein, receiving the request may include operations, features, means, or instructions for receiving, as part of the request, an indication of a duration of time to extend the active duration.

In some examples of the method, cells of a network entity, and non-transitory computer-readable medium described herein, the duration of time may be based on a packet size of the uplink transmission, a reference signal receive power condition of a channel associated with the uplink transmission, or both.

In some examples of the method, cells of a network entity, and non-transitory computer-readable medium described herein, a duration of time the active duration may be extended by may be semi-statically configured by the cell.

Some examples of the method, cells of a network entity, and non-transitory computer-readable medium described herein may further include operations, features, means, or instructions for transmitting second control signaling enabling the UE to request for extensions of the active duration of the cell DRX cycle based on a type of data traffic associated with the UE.

In some examples of the method, cells of a network entity, and non-transitory computer-readable medium described herein, the uplink transmission may be a low latency uplink transmission including URLLC data or XR data and the performance parameter may be a latency parameter and the threshold may be a latency threshold.

Some examples of the method, cells of a network entity, and non-transitory computer-readable medium described herein may further include operations, features, means, or instructions for transmitting an acknowledgment message indicating the request to extend the active duration may be accepted, where receiving the uplink transmission may be based on receiving the acknowledgment message.

In some examples of the method, cells of a network entity, and non-transitory computer-readable medium described herein, the request may be one of a SR message, a BSR message, UCI, a MAC-CE, or a PUCCH including a NACK.

Some examples of the method, cells of a network entity, and non-transitory computer-readable medium described herein may further include operations, features, means, or instructions for extending the active duration of the cell DRX cycle by a duration of time for the one or more cycles.

Some examples of the method, cells of a network entity, and non-transitory computer-readable medium described herein may further include operations, features, means, or instructions for generating an additional active duration relative to a current active duration of the cell DRX cycle for the one or more cycles, where a start of the additional active duration may be relative to an end of the current active duration.

### BRIEF DESCRIPTION OF THE DRAWINGS

FIG. 1 shows an example of a wireless communications system that supports techniques for cell active time extension in accordance with one or more aspects of the present disclosure.

FIG. 2 shows an example of a wireless communications system that supports techniques for cell active time extension in accordance with one or more aspects of the present disclosure.

FIGS. 3A and 3B each show a respective example of a cell discontinuous reception extension procedure that supports techniques for cell active time extension in accordance with one or more aspects of the present disclosure.

FIG. 4 shows an example of a process flow that supports techniques for cell active time extension in accordance with one or more aspects of the present disclosure.

FIGS. 5 and 6 show block diagrams of devices that support techniques for cell active time extension in accordance with one or more aspects of the present disclosure.

FIG. 7 shows a block diagram of a communications manager that supports techniques for cell active time extension in accordance with one or more aspects of the present disclosure.

FIG. 8 shows a diagram of a system including a device that supports techniques for cell active time extension in accordance with one or more aspects of the present disclosure.

FIGS. 9 and 10 show block diagrams of devices that support techniques for cell active time extension in accordance with one or more aspects of the present disclosure.

FIG. 11 shows a block diagram of a communications manager that supports techniques for cell active time extension in accordance with one or more aspects of the present disclosure.

FIG. 12 shows a diagram of a system including a device that supports techniques for cell active time extension in accordance with one or more aspects of the present disclosure.

FIGS. 13 through 16 show flowcharts illustrating methods that support techniques for cell active time extension in accordance with one or more aspects of the present disclosure.

### DETAILED DESCRIPTION

In some examples of wireless communications, a network entity may reduce power consumption by operating in accordance with one or more discontinuous communication modes. For example, a cell of the network entity may operate in accordance with a discontinuous reception (DRX) cycle, in which the cell may alternate between an active duration where the cell may monitor for communications and an inactive duration where the cell refrains from monitoring for communications. Additionally, or alternatively, the cell may operate in accordance with a discontinuous transmission (DTX) cycle, in which the call may alternate between an active duration where the cell may transmit signaling, and an inactive duration where the cell refrains from transmitting signaling. Additionally, or alternatively, the cell may operate in accordance with a cycle that includes a DTX cycle and a DRX cycle. In some cases of such a cycle, the DTX cycle and the DRX cycle may at least partially overlap in the time domain. In other cases of such a cycle, the DTX cycle and the DRX cycle may be mutually exclusive in the time domain. Throughout the specification descriptions and features that are described in the context of a DRX cycle may apply to a DTX cycle or a cycle that combines a DRX cycle and a DTX cycle.

As such, one or more wireless devices that communicate with the cell may operate in accordance with the one or more power saving modes of the cell. For instance, a user equipment (UE) may transmit one or more data packets during the active duration of the cell DRX cycle and refrain from transmitting during the inactive duration of the cell DRX cycle. In some cases, the UE may be scheduled to transmit a data packet near the end of the active duration of the cell DRX cycle. In such cases, if the UE transmits the data packet, the cell may receive at least a portion of the data packet during the inactive duration of the cell DRX cycle. As such, the UE may wait until the subsequent active duration of the cell DRX cycle to transmit the data packet. However, if the data packet is associated with delay sensitive data (e.g., ultra reliable low latency communications (URLLC) data or extended reality (XR) data), delaying transmission of the data packet may reduce user experience at the UE.

According to the techniques described herein, the cell may determine to extend the active duration of the cell DRX cycle based on the delay tolerance of data at the UE. For example, the UE may transmit a request for the cell to extend the active duration of the cell DRX cycle if the UE is scheduled to transmit a low latency uplink transmission (e.g., data associated with a latency parameter that satisfies a latency threshold). As such, the cell may extend the current active duration or generate an additional active duration, during which the UE may transmit the low latency uplink transmission. In some examples, the cell may semi-statically configure the duration of the extension. In some examples, the UE may dynamically indicate the duration of the extension based on one or more characteristics of the uplink transmission (e.g., a packet size of the uplink transmission, a quality of the uplink channel, or both).

Aspects of the disclosure are initially described in the context of wireless communications systems, cell DRX extension procedures, and a process flow. Aspects of the disclosure are further illustrated by and described with reference to apparatus diagrams, system diagrams, and flowcharts that relate to techniques for cell active time extension.

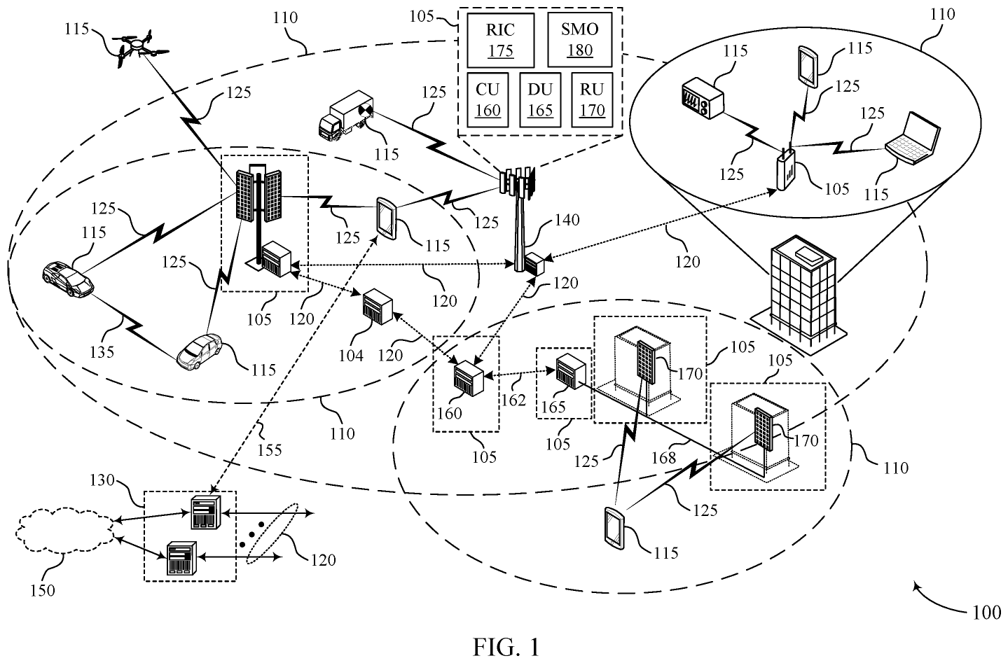

FIG. 1 shows an example of a wireless communications system 100 that supports techniques for cell active time extension in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for cell active time extension as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, one or more wireless devices may communicate with a cell of a network entity 105 in accordance with the one or more power saving modes of the cell. For instance, a UE 115 may transmit one or more data packets during the active duration of a cell DRX cycle and refrain from transmitting during the inactive duration of the cell DRX cycle. In some cases, the UE 115 may be scheduled to transmit a data packet near the end of the active duration of the cell DRX cycle. In such cases, if the UE 115 transmits the data packet, the cell may receive at least a portion of the data packet during the inactive duration of the cell DRX cycle. As such, the UE 115 may wait until the subsequent active duration of the cell DRX cycle to transmit the data packet. However, if the data packet is associated with delay sensitive data (e.g., URLLC data or XR data), delaying transmission of the data packet may reduce user experience at the UE 115.

According to the techniques described herein, the cell may determine to extend the active duration of the cell DRX cycle for one or more units of time based on the delay tolerance of data at the UE 115. For example, the UE 115 may transmit a request for the cell to extend the active duration of the cell DRX cycle if the UE 115 is scheduled to transmit a low latency uplink transmission (e.g., data associated with a latency parameter that satisfies a latency threshold). As such, the cell may extend the current active duration or generate an additional active duration, during which the UE 115 may transmit the low latency uplink transmission. In some examples, the cell may semi-statically configure the duration of the extension. In some examples, the UE 115 may dynamically indicate the duration of the extension based on one or more characteristics of the uplink transmission (e.g., a packet size of the uplink transmission, a quality of the uplink channel, or both).

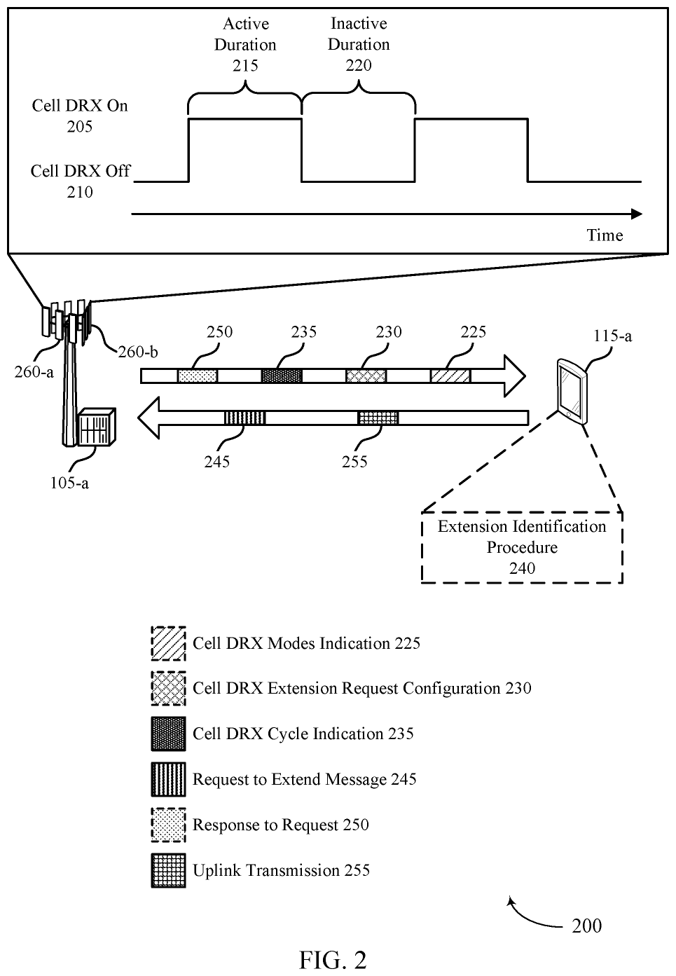

FIG. 2 shows an example of a wireless communications system 200 that supports techniques for cell active time extension in accordance with one or more aspects of the present disclosure. In some examples, the wireless communications system 200 may implement aspects of the wireless communications system 100. For example, the wireless communications system 200 may include a network entity 105-a and a UE 115-a, which may be examples of the corresponding devices described with reference to FIG. 1.

As illustrated in FIG. 2, the network entity 105-a may include or be associated with one or more cells 260 (e.g., cell 260-a and cell 260-b). The cells 260 of the network entity 105-a may include macro cells (e.g., primary cells used for wide-area coverage of a geographic area), small cells (e.g., micro cells, pico cells, or femto cells used to enhance capacity and coverage in high-density areas, indoors, or places with macro cell coverage below a threshold), multiple-input and multiple-output (MIMO) cells (e.g., to improve spectral efficiency and increase capacity in high-traffic areas), beamforming cells (e.g., utilize beamforming techniques to direct focused radio signals towards specific user devices, enhancing signal strength and reliability), among other examples. While FIG. 2 illustrates the network entity 105-a associated with two cells 260, it is understood that a wireless network may include any quantity of network entities 105 that are each associated with any quantity of cells 260.

In some examples of wireless communications system 200, the network entity 105-a may operate in accordance with one or more power saving modes. For example, cell DRX mode may be a technique employed in wireless networks to enhance energy efficiency and reduce energy consumption for one or more cells 260 of the network entity 105-a (e.g., in cases where data traffic is low or below a configured data threshold). As illustrated in FIG. 2, the cell 260-a may operate in accordance with a cell DRX cycle, which may alternate between an active duration 215 and an inactive duration 220. During the active duration 215 (e.g., cell DRX on 205), the cell 260-a may monitor for communications from one or more wireless devices serviced by the cell 260-a (e.g., the UE 115-a). During the inactive duration 220 (e.g., cell DRX off 210), the cell 260-a may refrain from monitoring for communications from the one or more wireless devices. As such, cell DRX may be a power-saving mechanism that allows cells 260 to periodically enter a sleep mode, thereby conserving energy during idle periods. Additionally, during the inactive duration 220 of the cell DRX, the one or more wireless devices may refrain from transmitting data to the cell 260-a, which may reduce power expenditure at the one or more wireless devices.

In some examples, the cell DRX mode may be cell specific (e.g., a first cell DRX mode for cell 260-a and a second DRX mode for cell 260-b). Additionally, each wireless device serviced by a given cell 260 may share a common DRX configuration, such that transmissions scheduled at the one or more wireless devices may be aligned with the active duration 215 of the cell DRX mode, which may allow the cell 260-a to refrain from monitoring for signals during the inactive duration 220. Additionally, or alternatively, each of the wireless devices may be configured with respective DRX modes (e.g., the UE 115-a may be configured with a UE DRX mode). In such examples, the cell 260-a may configure each of the one or more wireless devices, such that the respective DRX modes are staggered in accordance with multi-user scheduling. In some cases, if the UE 115-a is operating in a UE DRX inactive state, the UE 115-a may transmit periodic signals via a configured grant (CG) physical uplink shared channel (PUSCH), sounding reference signals (e.g., periodic, or semi-persistent scheduling (SPS)), or both.

Additionally, or alternatively, one or more cells 260 of the network entity 105-a may operate in accordance with a cell DTX mode. In examples of cell DTX, the cell 260-a may configure a cell DTX cycle, which similar to the cell DRX cycle, may alternate between an active duration 215 and an inactive duration 220. During an active duration 215 of the cell DTX, the cell 260-a may transmit data to the one or more serviced wireless devices. During the inactive duration 220 of the cell DTX, the cell 260-a may transition to an idle period, in which the cell 260-a may enter a sleep mode and refrain from transmitting data. As such, the cell DTX may be a power-saving mechanism that allows cells 260 to periodically enter a sleep mode, thereby conserving energy during idle periods. Additionally, during the inactive duration 220 of the cell DRX, the one or more wireless devices may refrain from monitoring for data from the cell 260-a, which may reduce power expenditure at the one or more wireless devices. While the techniques described herein are discussed relative to the cell DRX mode, it is understood that the techniques may apply to cell DTX mode, in addition to or alternatively to the cell DRX mode. For instance, cell DRX and cell DTX modes may be configured and operated separately (e.g., a first RRC configuration set for downlink and a second RRC configuration set for uplink) or cell DRX and cell DTX may be configured jointly (e.g., one RRC configuration set for both uplink and downlink).

The UE 115-a may communicate with the network entity 105-a in accordance with the one or more power saving modes of the network entity 105-a. For example, the UE 115-a may transmit uplink data or control signaling to the cell 260-a during the active duration 215 of the cell DRX cycle. In some cases, however, the UE 115-a may have a data packet (e.g., scheduled by the cell 260-a or unsolicited) that is scheduled for transmission within a threshold duration to the end of the active duration 215. In such cases, reception by the cell 260-a of the data packet may at least partially overlap with the inactive duration 220. As such, the UE 115-a may refrain from transmitting the data packet until a subsequent active duration 215 of the cell DRX mode. In some cases, however, the data packet at the UE 115-a may be associated with a low delay tolerance. For instance, the data packet may include ultra-reliable low latency (URLLC) data may include extended reality (XR) data. Accordingly, delaying transmission of a data packet with a low data tolerance may reduce performance at the UE 115-a.

According to the techniques described herein, the cell 260-a may determine to extend the active duration 215 of the cell DRX cycle based on the delay tolerance of data at the UE 115-a. For example, the cell 260-a may transmit a cell DRX cycle indication 235, which may be an example of control signaling that indicates the cell DRX cycle of the cell 260-a (e.g., length of active duration 215, length of inactive duration 220, periodicity, among other parameters).

In some examples, the cell DRX cycle indication 235 may be associated with the cell DRX modes indication 225. For instance, prior to the cell DRX cycle indication 235, the network entity 105-a may transmit a cell DRX modes indication 225 that includes a set cell DRX mode that the cell 260-a may operate in accordance with (e.g., respective cell DRX modes, each associated with respective cell DRX cycles that include a respective length of active duration 215, a respective length of inactive duration 220, and a respective periodicity). If the UE 115-a receives the cell DRX modes indication 225, the cell DRX cycle indication 235 may indicate a cell DRX mode from the set of cell DRX modes. In such examples, each cell DRX mode may be indicated by a string of bits, where the cell DRX cycle indication 235 includes the string of bits associated with the cell DRX mode for the cell 260-a. In some examples, the cell DRX modes indication 225 may be used to indicate the cell DRX mode associated with a plurality of the cells 260 of the network entity 105-a (e.g., all of the cells 260 of the network entity, in some cases). In some examples, the cell DRX modes indication 225 may be used to indicate the cell DRX mode for individual cells 260 of the network entity 105-a. In some examples, the network entity 105-a may configure the UE 115-a with a set of cell DRX modes as part of an RRC configuration (e.g., RRC signaling). Then a given cell 260 may select one cell DRX mode from the set of cell DRX modes with which to operate and may communicate the selected cell DRX mode with the UE 115-a via other control signaling (e.g., downlink control information (DCI) or medium access control-control element (MAC-CE)).

Based on identifying the cell DRX mode of the cell 260-a, the UE 115-a may transmit one or more uplink messages during the active duration 215 of the cell DRX mode. In some cases, the UE 115-a may determine that an uplink transmission 255 may at least overlap with the inactive duration 220 subsequent to the current active duration 215. As such, the UE 115-a may operate in accordance with an extension identification procedure 240 to determine whether the UE 115-a may request extension of the current active duration 215. As part of the extension identification procedure 240, the UE 115-a may determine a delay tolerance associated with the uplink transmission 255. For example, if the uplink transmission 255 includes latency sensitive data (e.g., URLLC data, XR data, among other examples) the UE 115-a may compare a latency value associated with the data to a latency threshold. As such, if the data of the uplink transmission 255 satisfies the latency threshold, then the UE 115-a may transmit a request to extend message 245, which may indicate for the cell 260-a to extend the current active duration 215.

In some examples, the cell 260-a may enable and disable the ability of the UE 115-a to transmit the request to extend message 245. For instance, the cell 260-a may transmit a cell DRX extension request configuration 230, which may enable the UE 115-a to transmit the request to extend message 245, or disable the UE 115-a from transmitting the request to extend message 245. As such, the UE 115-a may use the extension identification procedure 240 in accordance with whether the UE 115-a is enabled to transmit the request to extend message 245.

In some examples, the UE 115-a may transmit the request to extend message 245 at a duration offset (e.g., a time delta) prior to an end time of the current active duration 215. The duration offset may be defined at the UE 115-a (e.g., preconfigured) or indicated by the network entity 105-a via control signaling (e.g., via the cell DRX extension request configuration 230).

In some examples, the UE 115-a may include the request to extend message 245 in a buffer status report (BSR) message. In some cases, the BSR message may be a transmitted without be requested (e.g., solicited) by the network entity 105-a. For instance, the UE 115-a may transmit an unsolicited BSR at a time that satisfies the duration offset. In some examples, the BSR may include a quantity of non-zero values that satisfies a quantity threshold (e.g., the quantity of non-zero values is less than the quantity threshold). As such, the quantity of non-zero values satisfying the quantity threshold may be indicative of the request to extend message 245.

In some examples, the UE 115-a may include the request to extend message 245 in a scheduling request (SR) message. For instance, the SR message may be associated with an SR codebook, where the SR codebook differentiates whether the UE 115-a is requesting an extension for the current active duration 215. For example, a first bit value in the SR message (e.g., a bit value of 0 or 1), may indicate no extension of the current active duration, and a second bit value in the SR message (e.g., a bit value opposite of the first bit value) may indicate the request to extend message 245.

As described herein, the UE 115-a may include the request to extend message 245 in various message types. For example, the UE 115-a request to extend message 245 may be included in an SR message, a BSR message (e.g., solicited, or unsolicited), an uplink control information (UCI) message, a MAC-CE, or a physical uplink control channel (PUCCH) that includes a negative acknowledgment (NACK).

If the network entity 105-a receives the request to extend message 245, the network entity 105-a and the UE 115-a may assume that the active duration 215 is extended by a value of X. The value of X may indicate a duration of time, a quantity of slots, sub-slots, or any other type of TTI value, or any combination thereof. In some examples, the cell 260-a may indicate the value of X in the cell DRX extension request configuration 230. In some examples, the cell may semi-statically configure the value of X (e.g., in an RRC message, a DCI, a medium access control-control message, or in a physical downlink control channel (PDCCH)). In some examples, the UE 115-a may dynamically indicate the value of X (e.g., as part of the request to extend message 245, or a separate control message). In some examples, the UE 115-a may determine the value of X based on the packet size of the uplink transmission 255, such that as the packet size increases the value of X increases. Additionally, or alternatively, the UE 115-a may determine the value of X based on a reference signal receive power (RSRP) condition of the channel with the cell 260-a, such that as an RSRP value decreases for the channel (e.g., channel quality decreases) the value of X may increase.

In some examples, the cell 260-a may respond to the request to extend message (e.g., the cell 260-a may transmit a response to request 250). If the response to request 250 indicates an acknowledgment (ACK), then the cell 260-a has extended the current active duration 215, and the UE 115-a may proceed with transmitting the uplink transmission 255 during the extended active duration. If the response to request 250 indicates a NACK, then the cell 260-a has declined the request to extend message 245, and the UE 115-a may wait until the subsequent active duration 215 to transmit the uplink transmission 255. If the cell 260-a refrains from transmitting the response to request 250, the UE 115-a may assume that the current active duration 215 is extended and transmit the uplink transmission 255 during the extended active duration 215.

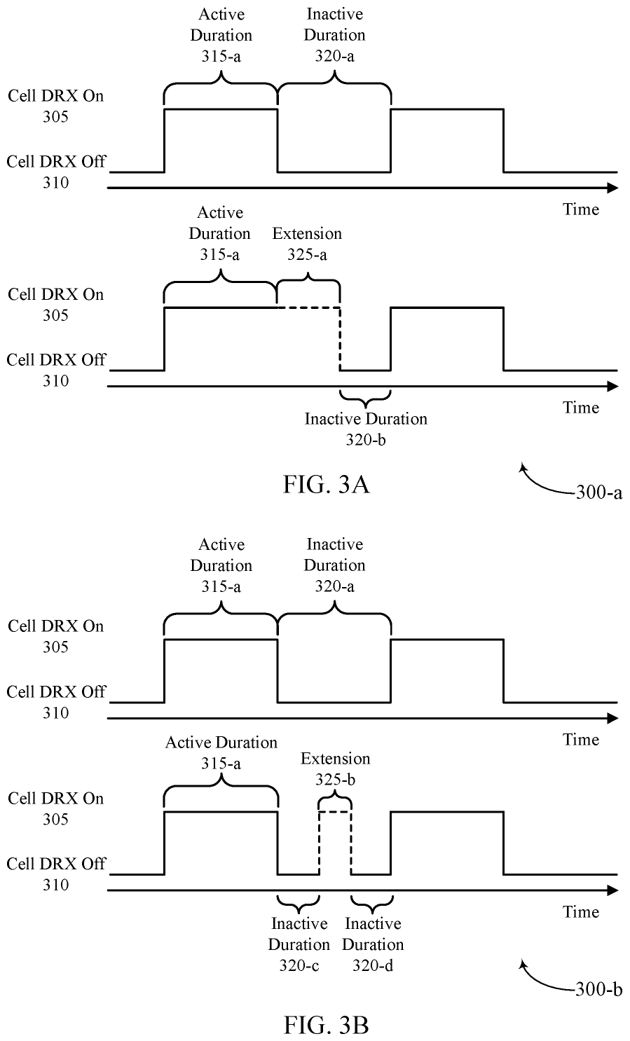

In some examples, the cell 260-a may include the extension directly after the end of current active duration 215, as described with reference to FIG. 3A. In some examples, the cell 260-a may include the extension a duration after the end of the current active duration 215 and prior to the subsequent active duration 215, as described with reference to FIG. 3B.

FIGS. 3A and 3B show examples of a cell DRX extension procedure 300-a and 300-b that supports techniques for cell active time extension in accordance with one or more aspects of the present disclosure. In some examples, the cell DRX extension procedure 300 may implement aspects of the wireless communications system 100 and 200. For example, cell DRX on 305, cell DRX off 310, active duration 315, and inactive duration 320 may be respective examples of cell DRX on 205, cell DRX 210 off, active duration 215, and inactive duration 220. In some examples, a cell of a network entity may apply an extension 325 to the active duration 315 in accordance with the techniques of FIG. 3A or 3B.

As illustrated in both FIGS. 3A and 3B, a cell of the network entity may operate in accordance with a cell DRX mode that includes an active duration 315-a and an inactive duration 320-a. As described, with reference to FIG. 2, the cell DRX mode may correspond to cell DRX cycle, in which the cell periodically alternates between the active duration 315 and the inactive duration 320. As such, a single cycle of the cell DRX mode may include an active duration 315-a and an inactive duration 320-a. Additionally, for a given cell DRX cycle, the cell may operate in the active duration 315-a for a first duration of time and operate in the inactive duration 320-a for a second duration of time, where the first and second durations of time may be the same or different values configured by the cell.

As illustrated in FIG. 3A, the cell may apply an extension 325 to the active duration 315-a. For example, the cell may apply an extension 325-a directly subsequent to the end time of the active duration 315-a. As such, the cell may remain in cell DRX on 305 and monitor for data from one or more wireless devices during the extension 325-a. In some examples, the extension 325-a may occur during at least a portion of the inactive duration 320-a. In such examples, the cell may reconfigure inactive duration 320-a to an inactive duration 320-b, where inactive duration 320-b is the resulting difference of inactive duration 320-a and the extension 325-a. Alternatively, the cell may include the extension 325-a and shift the cell DRX cycle. That is, the cell may maintain the inactive duration 320-a directly subsequent to the end of extension 325-a.

The cell may configure the extension 325-a for the current active duration 315-a or for multiple subsequent active durations 315. For example, the cell may indicate via a control message (e.g., cell DRX extension request configuration 230 or response to request 250) an indication of which active durations 315 the cell has applied the extension 325-a.

As illustrated in FIG. 3B, the cell may apply an extension 325-b after the end time of active duration 315-a. In some examples, the cell may reconfigure a portion of inactive duration 320-a to serve as the extension 325-b. For instance, the cell may reconfigure inactive duration 320-a to include the extension 325-b with an inactive duration 320-c prior to the extension 325-b and an inactive duration 320-d after the extension 325-b. As such, the cell may transition back to cell DRX on 305 and monitor for data from one or more wireless devices during the extension 325-b.

The cell may configure the extension 325-b during the current inactive duration 320-a or for multiple subsequent inactive durations 320. For example, the cell may indicate via a control message (e.g., cell DRX extension request configuration 230 or response to request 250) an indication of which inactive durations 320 the cell has applied the extension 325-b. Additionally, the control message may indicate the duration between the end of active duration 315-a and the start time of extension 325-b (e.g., inactive duration 320-c).

As described with reference to FIG. 2, the duration of extension 325-a or 325-b may be a value of X, where the value is predetermined, semi-statically configured by the cell, or dynamically indicated by a UE requesting for the extension 325.

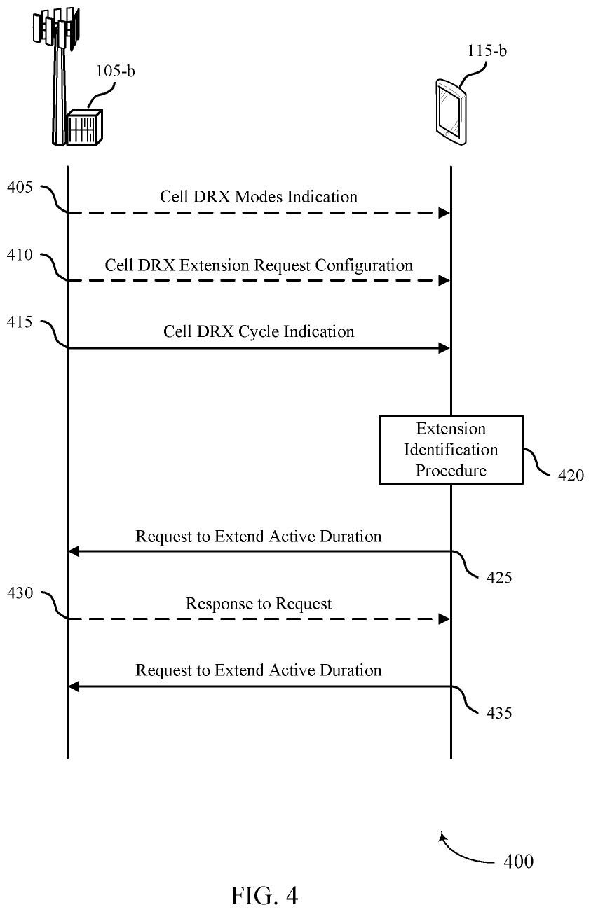

FIG. 4 shows an example of a process flow 400 that supports techniques for cell active time extension in accordance with one or more aspects of the present disclosure. In some examples, process flow 400 may implement aspects of wireless communications system 100 and 200 and cell DRX extension procedures 300-a and 300-b. Process flow 400 includes a UE 115-b and a network entity 105-b which may be respective examples of a UE 115 and a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, while process flow 400 shows processes between a single UE 115 and a single network entity 105, these processes may occur between any quantity of network devices and network device types.

In some examples, at 405 the UE 115-b may receive control signaling that indicates a set of cell DRX modes associated with a cell of the network entity 105-b (e.g., cell DRX modes indication 225).

In some examples, at 410 the UE 115-b may receive control signaling enabling the UE 115-b to request for extensions of the active duration of the cell DRX cycle based on a type of data traffic associated with the UE 115-b (e.g., cell DRX extension request configuration 230).

At 415, the UE 115-b may receive control signaling that indicates a DRX cycle for a cell communicating with the UE 115-b. In some cases, the cell DRX cycle may alternate between an active duration during which the cell is monitoring for communications and an inactive duration during which the cell refrains from monitoring for communications. If the UE 115-b receives the cell DRX modes indication (at 405), then the control signaling that indicated the cell DRX cycle may indicate the cell is operating in accordance with a first cell DRX mode of the set of cell DRX modes (e.g., the first cell DRX mode includes the cell DRX cycle).

In some examples, the UE 115-b may determine to transmit an uplink transmission that may at least partially overlap with the inactive duration of the cell DRX cycle. In such examples, at 420, the UE 115-b may perform an extension identification procedure to determine whether to request an extension of the active duration of the cell DRX cycle. In some examples, the extension identification procedure may analyze a performance parameter associated with the uplink transmission. For example, the uplink transmission may be a low latency transmission that includes URLLC communication data or XR data, where the performance parameter may be a latency parameter. As such, the UE 115-b may compare the latency parameter of the uplink transmission to a latency threshold. If the latency parameter of the uplink transmission satisfies the latency threshold, then the UE 115-b may determine to request extension of the active duration of the cell DRX cycle. In some examples, the UE 115-b may perform the extension identification procedure based on the cell DRX extension request configuration (at 410) enabling the UE to request extension of the active duration.

At 425, the UE 115-b may transmit a request to extend the active duration of the cell DRX cycle during one or more cycles of the cell DRX cycle. In some examples, transmitting the request may be based on the performance parameter associated with an uplink transmission satisfying the associated threshold. In some examples, the UE 115-b may transmit the request at or before a time that is a duration prior to an end time of a current active duration of the cell DRX cycle. In some examples, the request may be a BFR that includes a quantity of non-zero values, where transmitting the request may be based on the quantity of non-zero values satisfying a quantity threshold. In some examples, the request may include a value associated with an SR codebook, where a first value indicates that the cell is to maintain the cell DRX cycle, and a second value indicates that the cell is to extend the active duration. In some examples, the request may be one of an SR message, a BFR message, UCI, a MAC-CE, or a PUCCH including a NACK.

In some examples, the UE 115-b may identify a duration of time that the active duration is to be extended (e.g., value of X) based on transmitting the request. In some examples, the UE 115-b may transmit, as part of the request, an indication of the duration of time to extend the active duration. For example, the duration of time may be based on a packet size of the uplink transmission, an RSRP condition of a channel associated with the uplink transmission, or both. In some examples, the cell of the network entity 105-b may semi-statically configure the duration of time the active duration is extended by.

In some examples, at 430, the UE 115-b may receive a response to the request to extend the active duration. For example, the UE 115-b may receive an ACK message indicating the request to extend the active duration is successfully received. In some examples, transmitting the uplink transmission may be based on receiving the acknowledgment message.

At 435, the UE 115-b may transmit the uplink transmission during the active duration of a cycle that is extended based on transmitting the request. In some examples, the DRX cycle may be extended in accordance with the techniques of FIG. 3A (e.g., directly after the current active duration). In some examples, the DRX cycle may be extended in accordance with the techniques of FIG. 3B (e.g., during the subsequent inactive duration).

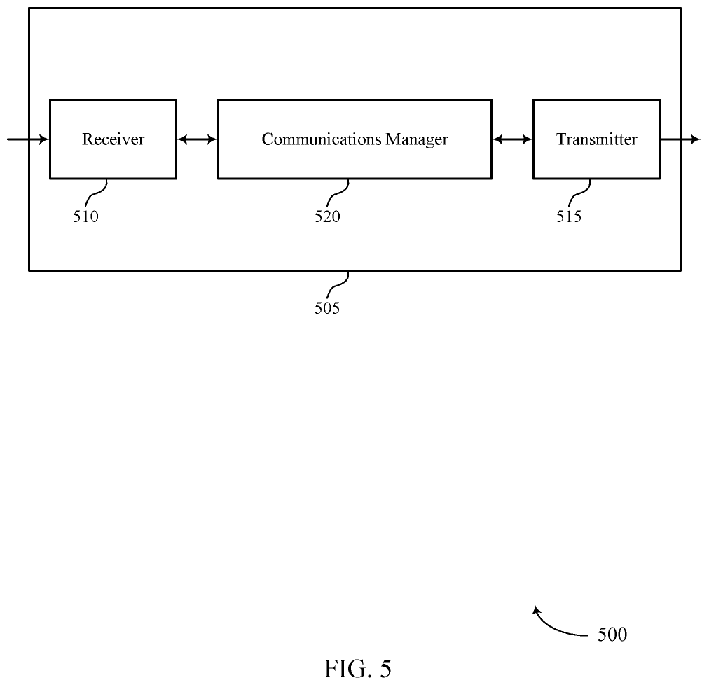

FIG. 5 shows a block diagram 500 of a device 505 that supports techniques for cell active time extension in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for cell active time extension). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for cell active time extension). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for cell active time extension as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling that indicates a cell DRX cycle for a cell communicating with the UE, the cell DRX cycle alternating between an active duration during which the cell is monitoring for communications and an inactive duration during which the cell refrains from monitoring for communications. The communications manager 520 is capable of, configured to, or operable to support a means for transmitting a request to extend the active duration of the cell DRX cycle during one or more cycles of the cell DRX cycle, where transmitting the request is based on a performance parameter associated with an uplink transmission satisfying a threshold. The communications manager 520 is capable of, configured to, or operable to support a means for transmitting the uplink transmission during the active duration of a cycle that is extended based on transmitting the request.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced latency, reduced power consumption, more efficient utilization of communication resources.

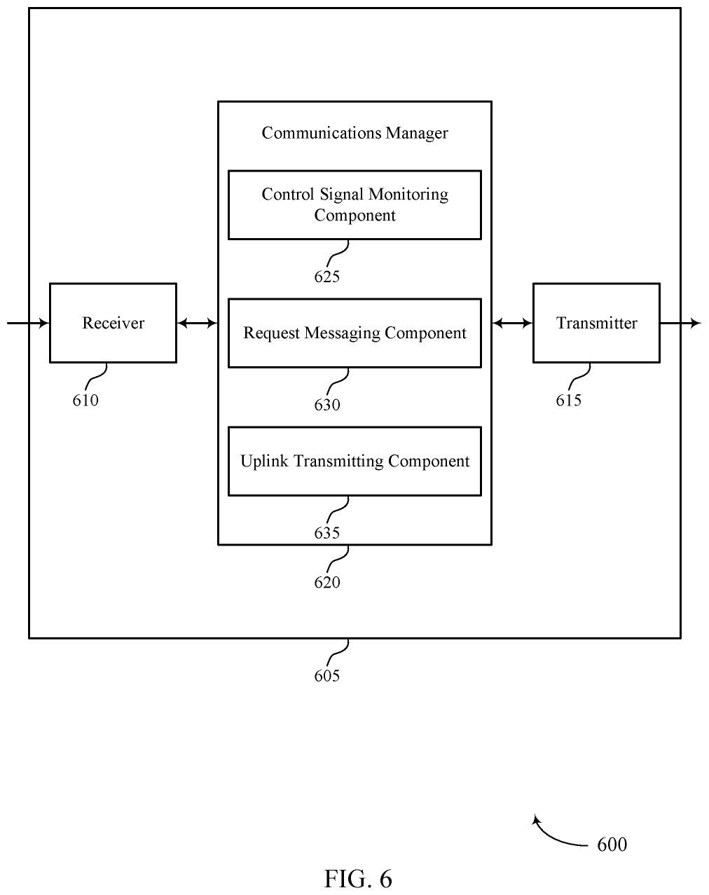

FIG. 6 shows a block diagram 600 of a device 605 that supports techniques for cell active time extension in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for cell active time extension). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for cell active time extension). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for cell active time extension as described herein. For example, the communications manager 620 may include a control signal monitoring component 625, a request messaging component 630, an uplink transmitting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control signal monitoring component 625 is capable of, configured to, or operable to support a means for receiving control signaling that indicates a cell DRX cycle for a cell communicating with the UE, the cell DRX cycle alternating between an active duration during which the cell is monitoring for communications and an inactive duration during which the cell refrains from monitoring for communications. The request messaging component 630 is capable of, configured to, or operable to support a means for transmitting a request to extend the active duration of the cell DRX cycle during one or more cycles of the cell DRX cycle, where transmitting the request is based on a performance parameter associated with an uplink transmission satisfying a threshold. The uplink transmitting component 635 is capable of, configured to, or operable to support a means for transmitting the uplink transmission during the active duration of a cycle that is extended based on transmitting the request.

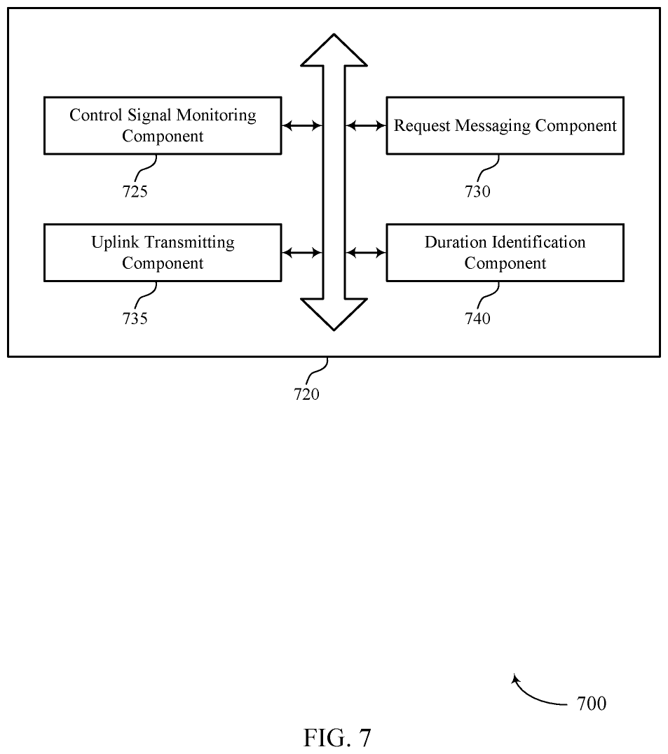

FIG. 7 shows a block diagram 700 of a communications manager 720 that supports techniques for cell active time extension in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for cell active time extension as described herein. For example, the communications manager 720 may include a control signal monitoring component 725, a request messaging component 730, an uplink transmitting component 735, a duration identification component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control signal monitoring component 725 is capable of, configured to, or operable to support a means for receiving control signaling that indicates a cell DRX cycle for a cell communicating with the UE, the cell DRX cycle alternating between an active duration during which the cell is monitoring for communications and an inactive duration during which the cell refrains from monitoring for communications. The request messaging component 730 is capable of, configured to, or operable to support a means for transmitting a request to extend the active duration of the cell DRX cycle during one or more cycles of the cell DRX cycle, where transmitting the request is based on a performance parameter associated with an uplink transmission satisfying a threshold. The uplink transmitting component 735 is capable of, configured to, or operable to support a means for transmitting the uplink transmission during the active duration of a cycle that is extended based on transmitting the request.

In some examples, the control signal monitoring component 725 is capable of, configured to, or operable to support a means for receiving second control signaling that indicates a set of multiple cell DRX modes associated with the cell, where receiving the control signaling includes receiving an indication to activate a first cell DRX mode of the set of multiple cell DRX modes, where the first cell DRX mode includes the DRX cycle.

In some examples, to support transmitting the request, the request messaging component 730 is capable of, configured to, or operable to support a means for transmitting the request at or before a time that is a duration prior to an end time of a current active duration of the cell DRX cycle.

In some examples, the request is a BSR including a quantity of non-zero values. In some examples, transmitting the request is based on the quantity of non-zero values satisfying a quantity threshold.

In some examples, the duration identification component 740 is capable of, configured to, or operable to support a means for identifying a duration of time that the active duration is to be extended based on transmitting the request.

In some examples, to support transmitting the request, the request messaging component 730 is capable of, configured to, or operable to support a means for transmitting, as part of the request, an indication of a duration of time to extend the active duration.

In some examples, the duration of time is based on a packet size of the uplink transmission, a reference signal receive power condition of a channel associated with the uplink transmission, or both.

In some examples, a duration of time the active duration is extended by is semi-statically configured by the cell.

In some examples, the control signal monitoring component 725 is capable of, configured to, or operable to support a means for receiving second control signaling enabling the UE to request for extensions of the active duration of the cell DRX cycle based on a type of data traffic associated with the UE.

In some examples, the uplink transmission is a low latency uplink transmission including URLLC data or extended reality data. In some examples, the performance parameter is a latency parameter, and the threshold is a latency threshold.

In some examples, the control signal monitoring component 725 is capable of, configured to, or operable to support a means for receiving an acknowledgment message indicating the request to extend the active duration is successfully received, where transmitting the uplink transmission is based on receiving the acknowledgment message.

In some examples, the request is one of a SR message, a BSR message, UCI, a MAC-CE, or a PUCCH including a NACK.

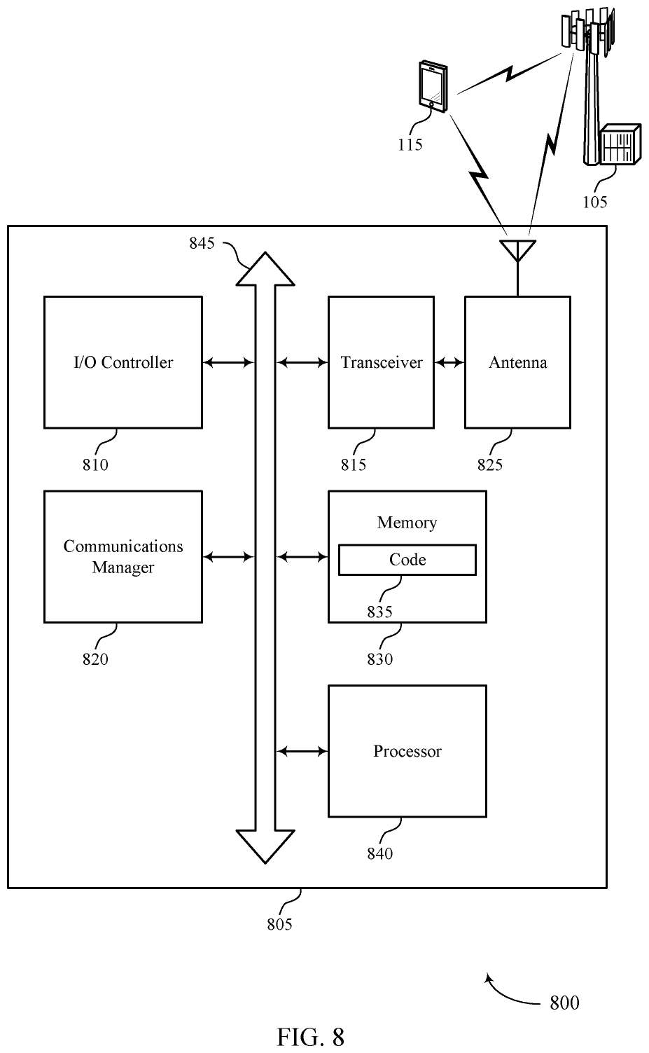

FIG. 8 shows a diagram of a system 800 including a device 805 that supports techniques for cell active time extension in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for cell active time extension). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for receiving control signaling that indicates a cell DRX cycle for a cell communicating with the UE, the cell DRX cycle alternating between an active duration during which the cell is monitoring for communications and an inactive duration during which the cell refrains from monitoring for communications. The communications manager 820 is capable of, configured to, or operable to support a means for transmitting a request to extend the active duration of the cell DRX cycle during one or more cycles of the cell DRX cycle, where transmitting the request is based on a performance parameter associated with an uplink transmission satisfying a threshold. The communications manager 820 is capable of, configured to, or operable to support a means for transmitting the uplink transmission during the active duration of a cycle that is extended based on transmitting the request.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for cell active time extension as described herein, or the at least one processor 840 and the at least one memory 830 may be otherwise configured to, individually or collectively, perform or support such operations.

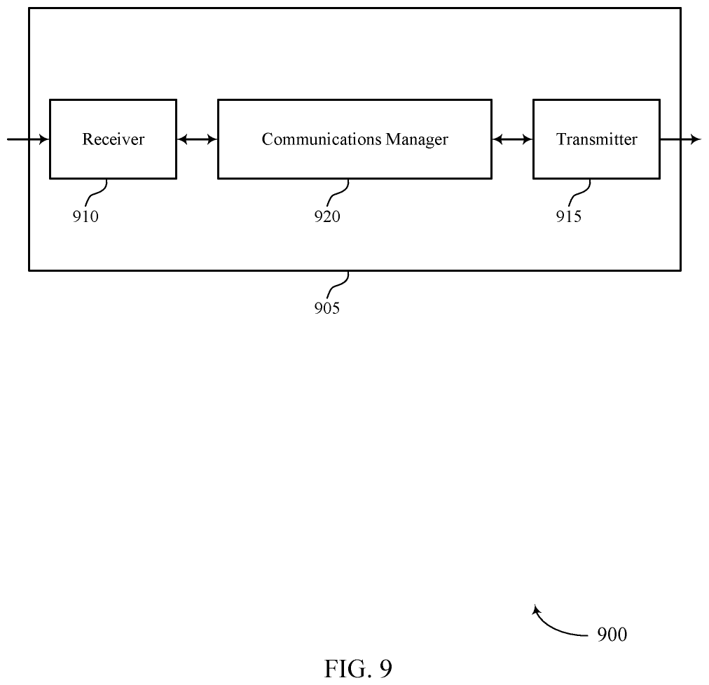

FIG. 9 shows a block diagram 900 of a device 905 that supports techniques for cell active time extension in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for cell active time extension as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling that indicates a cell DRX cycle for the cell communicating with a UE, the cell DRX cycle alternating between an active duration during which the cell is monitoring for communications and an inactive duration during which the cell refrains from monitoring for communications. The communications manager 920 is capable of, configured to, or operable to support a means for receiving a request to extend the active duration of the cell DRX cycle during one or more cycles of the cell DRX cycle, where transmitting the request is based on a performance parameter associated with an uplink transmission satisfying a threshold. The communications manager 920 is capable of, configured to, or operable to support a means for receiving the uplink transmission during the active duration of a cycle that is extended based on transmitting the request.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced latency, reduced power consumption, and more efficient utilization of communication resources.

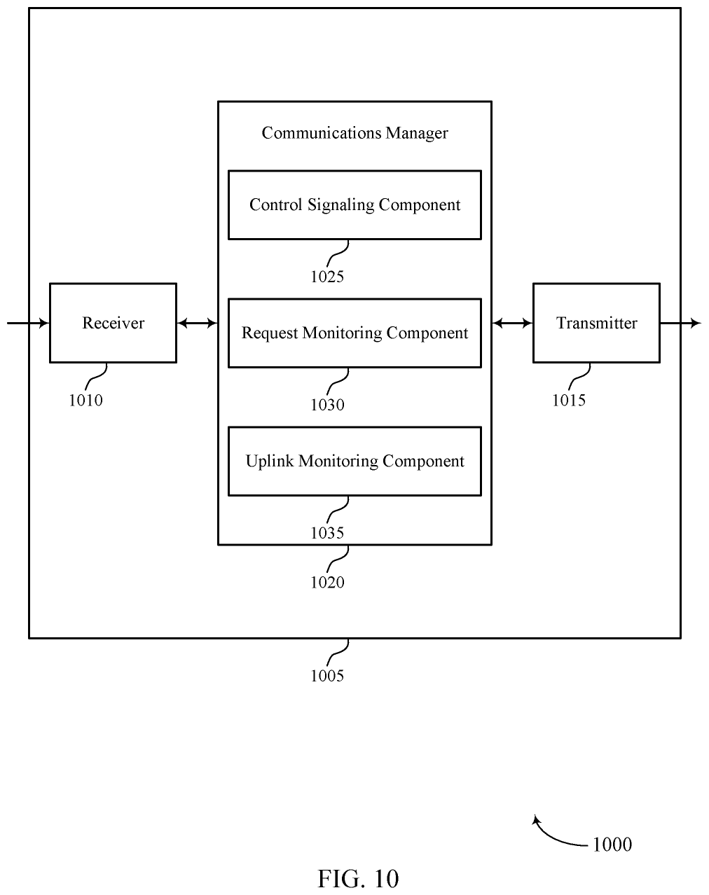

FIG. 10 shows a block diagram 1000 of a device 1005 that supports techniques for cell active time extension in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for cell active time extension as described herein. For example, the communications manager 1020 may include a control signaling component 1025, a request monitoring component 1030, an uplink monitoring component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling component 1025 is capable of, configured to, or operable to support a means for transmitting control signaling that indicates a cell DRX cycle for the cell communicating with a UE, the cell DRX cycle alternating between an active duration during which the cell is monitoring for communications and an inactive duration during which the cell refrains from monitoring for communications. The request monitoring component 1030 is capable of, configured to, or operable to support a means for receiving a request to extend the active duration of the cell DRX cycle during one or more cycles of the cell DRX cycle, where transmitting the request is based on a performance parameter associated with an uplink transmission satisfying a threshold. The uplink monitoring component 1035 is capable of, configured to, or operable to support a means for receiving the uplink transmission during the active duration of a cycle that is extended based on transmitting the request.

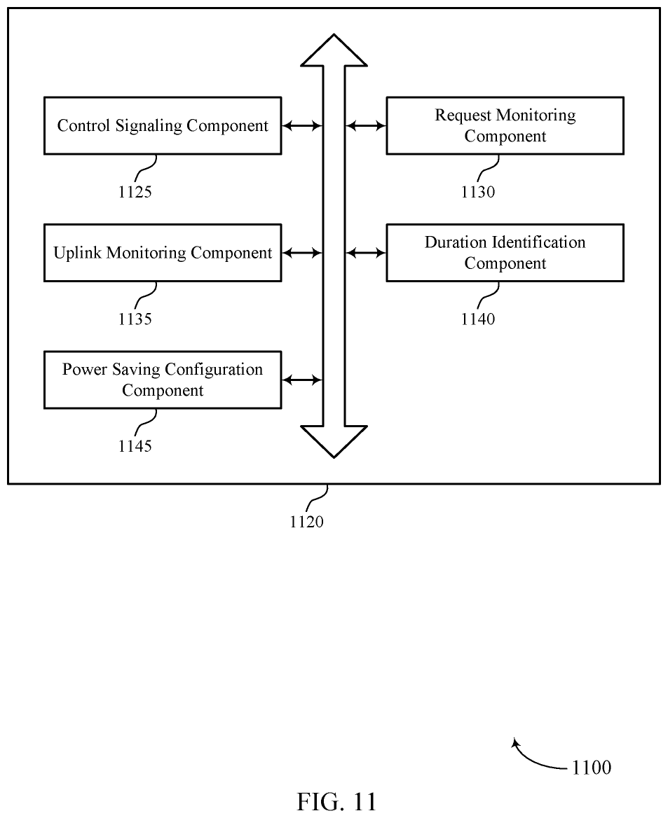

FIG. 11 shows a block diagram 1100 of a communications manager 1120 that supports techniques for cell active time extension in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for cell active time extension as described herein. For example, the communications manager 1120 may include a control signaling component 1125, a request monitoring component 1130, an uplink monitoring component 1135, a duration identification component 1140, a power saving configuration component 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control signaling component 1125 is capable of, configured to, or operable to support a means for transmitting control signaling that indicates a cell DRX cycle for the cell communicating with a UE, the cell DRX cycle alternating between an active duration during which the cell is monitoring for communications and an inactive duration during which the cell refrains from monitoring for communications. The request monitoring component 1130 is capable of, configured to, or operable to support a means for receiving a request to extend the active duration of the cell DRX cycle during one or more cycles of the cell DRX cycle, where transmitting the request is based on a performance parameter associated with an uplink transmission satisfying a threshold. The uplink monitoring component 1135 is capable of, configured to, or operable to support a means for receiving the uplink transmission during the active duration of a cycle that is extended based on transmitting the request.

In some examples, the control signaling component 1125 is capable of, configured to, or operable to support a means for transmitting second control signaling that indicates a set of multiple cell DRX modes associated with the cell, where transmitting the control signaling includes transmitting an indication to activate a first cell DRX mode of the set of multiple cell DRX modes, where the first cell DRX mode includes the cell DRX cycle.

In some examples, to support receiving the request, the request monitoring component 1130 is capable of, configured to, or operable to support a means for receiving the request at or before a time that is a duration prior to an end time of a current active duration of the cell DRX cycle.

In some examples, the request is a BSR including a quantity of non-zero values. In some examples, receiving the request is based on the quantity of non-zero values satisfying a quantity threshold.

In some examples, the duration identification component 1140 is capable of, configured to, or operable to support a means for identifying a duration of time that the active duration is to be extended based on receiving the request.

In some examples, to support receiving the request, the request monitoring component 1130 is capable of, configured to, or operable to support a means for receiving, as part of the request, an indication of a duration of time to extend the active duration.

In some examples, the duration of time is based on a packet size of the uplink transmission, a reference signal receive power condition of a channel associated with the uplink transmission, or both.

In some examples, a duration of time the active duration is extended by is semi-statically configured by the cell.

In some examples, the control signaling component 1125 is capable of, configured to, or operable to support a means for transmitting second control signaling enabling the UE to request for extensions of the active duration of the cell DRX cycle based on a type of data traffic associated with the UE.

In some examples, the uplink transmission is a low latency uplink transmission including URLLC data or extended reality data. In some examples, the performance parameter is a latency parameter, and the threshold is a latency threshold.

In some examples, the control signaling component 1125 is capable of, configured to, or operable to support a means for transmitting an acknowledgment message indicating the request to extend the active duration is accepted, where receiving the uplink transmission is based on receiving the acknowledgment message.

In some examples, the request is one of a SR message, a BSR message, UCI, a MAC-CE, or a PUCCH including a NACK.

In some examples, the power saving configuration component 1145 is capable of, configured to, or operable to support a means for extending the active duration of the cell DRX cycle by a duration of time for the one or more cycles.

In some examples, the power saving configuration component 1145 is capable of, configured to, or operable to support a means for generating an additional active duration relative to a current active duration of the cell DRX cycle for the one or more cycles, where a start of the additional active duration is relative to an end of the current active duration.

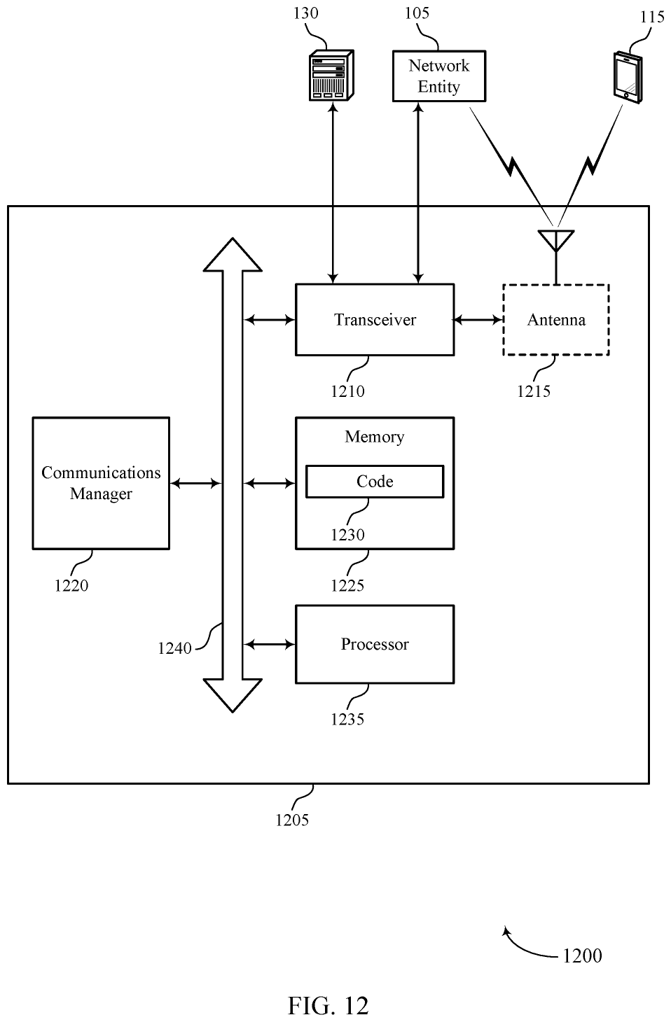

FIG. 12 shows a diagram of a system 1200 including a device 1205 that supports techniques for cell active time extension in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for cell active time extension). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling that indicates a cell DRX cycle for the cell communicating with a UE, the cell DRX cycle alternating between an active duration during which the cell is monitoring for communications and an inactive duration during which the cell refrains from monitoring for communications. The communications manager 1220 is capable of, configured to, or operable to support a means for receiving a request to extend the active duration of the cell DRX cycle during one or more cycles of the cell DRX cycle, where transmitting the request is based on a performance parameter associated with an uplink transmission satisfying a threshold. The communications manager 1220 is capable of, configured to, or operable to support a means for receiving the uplink transmission during the active duration of a cycle that is extended based on transmitting the request.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for cell active time extension as described herein, or the at least one processor 1235 and the at least one memory 1225 may be otherwise configured to, individually or collectively, perform or support such operations.

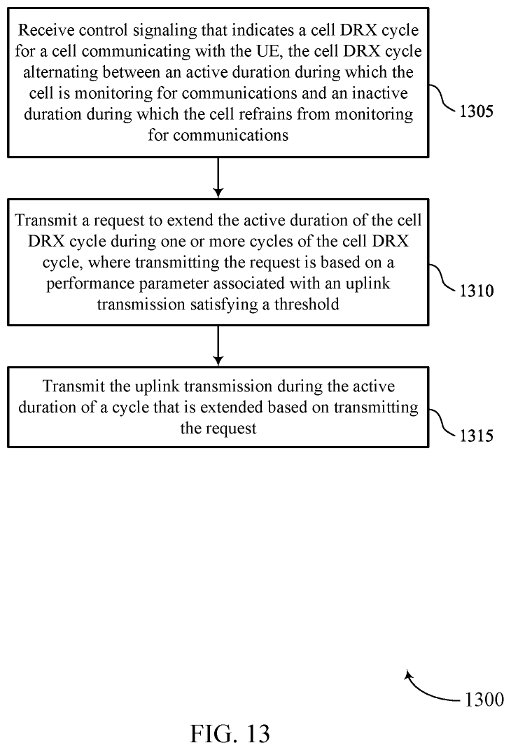

FIG. 13 shows a flowchart illustrating a method 1300 that supports techniques for cell active time extension in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates a cell DRX cycle for a cell communicating with the UE, the cell DRX cycle alternating between an active duration during which the cell is monitoring for communications and an inactive duration during which the cell refrains from monitoring for communications. The operations of block 1305 may be performed in accordance with examples as disclosed herein. In some examples, aspects of the operations of 1305 may be performed by a control signal monitoring component 725 as described with reference to FIG. 7.

At 1310, the method may include transmitting a request to extend the active duration of the cell DRX cycle during one or more cycles of the cell DRX cycle, where transmitting the request is based on a performance parameter associated with an uplink transmission satisfying a threshold. The operations of block 1310 may be performed in accordance with examples as disclosed herein. In some examples, aspects of the operations of 1310 may be performed by a request messaging component 730 as described with reference to FIG. 7.

At 1315, the method may include transmitting the uplink transmission during the active duration of a cycle that is extended based on transmitting the request. The operations of block 1315 may be performed in accordance with examples as disclosed herein. In some examples, aspects of the operations of 1315 may be performed by an uplink transmitting component 735 as described with reference to FIG. 7.

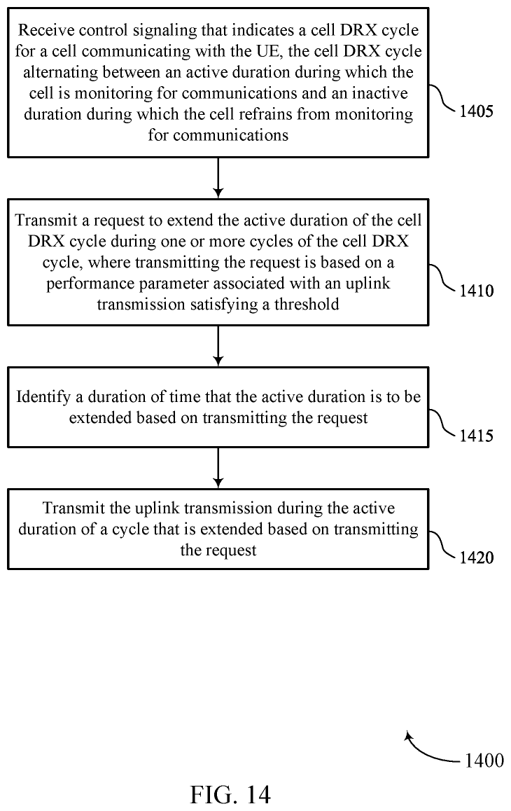

FIG. 14 shows a flowchart illustrating a method 1400 that supports techniques for cell active time extension in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a cell DRX cycle for a cell communicating with the UE, the cell DRX cycle alternating between an active duration during which the cell is monitoring for communications and an inactive duration during which the cell refrains from monitoring for communications. The operations of block 1405 may be performed in accordance with examples as disclosed herein. In some examples, aspects of the operations of 1405 may be performed by a control signal monitoring component 725 as described with reference to FIG. 7.

At 1410, the method may include transmitting a request to extend the active duration of the cell DRX cycle during one or more cycles of the cell DRX cycle, where transmitting the request is based on a performance parameter associated with an uplink transmission satisfying a threshold. The operations of block 1410 may be performed in accordance with examples as disclosed herein. In some examples, aspects of the operations of 1410 may be performed by a request messaging component 730 as described with reference to FIG. 7.

At 1415, the method may include identifying a duration of time that the active duration is to be extended based on transmitting the request. The operations of block 1415 may be performed in accordance with examples as disclosed herein. In some examples, aspects of the operations of 1415 may be performed by a duration identification component 740 as described with reference to FIG. 7.

At 1420, the method may include transmitting the uplink transmission during the active duration of a cycle that is extended based on transmitting the request. The operations of block 1420 may be performed in accordance with examples as disclosed herein. In some examples, aspects of the operations of 1420 may be performed by an uplink transmitting component 735 as described with reference to FIG. 7.

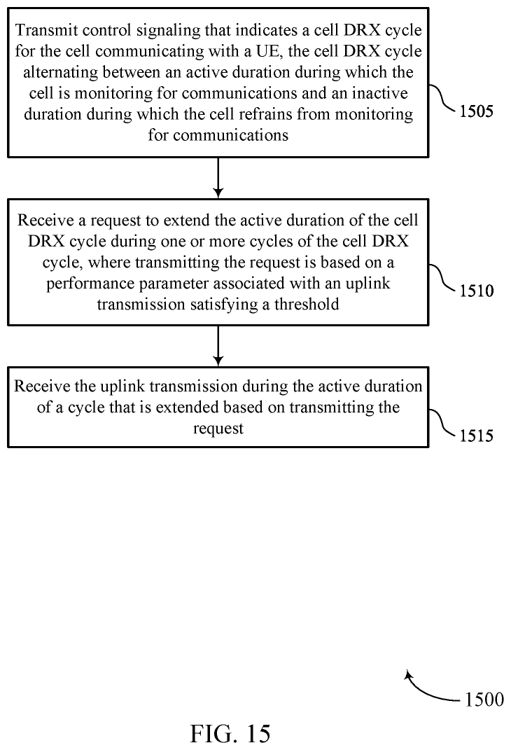

FIG. 15 shows a flowchart illustrating a method 1500 that supports techniques for cell active time extension in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that indicates a cell DRX cycle for the cell communicating with a UE, the cell DRX cycle alternating between an active duration during which the cell is monitoring for communications and an inactive duration during which the cell refrains from monitoring for communications. The operations of block 1505 may be performed in accordance with examples as disclosed herein. In some examples, aspects of the operations of 1505 may be performed by a control signaling component 1125 as described with reference to FIG. 11.

At 1510, the method may include receiving a request to extend the active duration of the cell DRX cycle during one or more cycles of the cell DRX cycle, where transmitting the request is based on a performance parameter associated with an uplink transmission satisfying a threshold. The operations of block 1510 may be performed in accordance with examples as disclosed herein. In some examples, aspects of the operations of 1510 may be performed by a request monitoring component 1130 as described with reference to FIG. 11.

At 1515, the method may include receiving the uplink transmission during the active duration of a cycle that is extended based on transmitting the request. The operations of block 1515 may be performed in accordance with examples as disclosed herein. In some examples, aspects of the operations of 1515 may be performed by an uplink monitoring component 1135 as described with reference to FIG. 11.

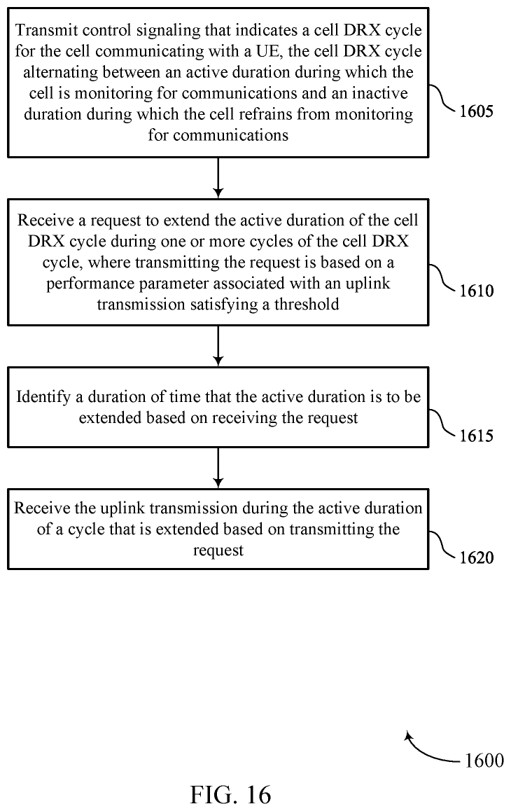

FIG. 16 shows a flowchart illustrating a method 1600 that supports techniques for cell active time extension in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling that indicates a cell DRX cycle for the cell communicating with a UE, the cell DRX cycle alternating between an active duration during which the cell is monitoring for communications and an inactive duration during which the cell refrains from monitoring for communications. The operations of block 1605 may be performed in accordance with examples as disclosed herein. In some examples, aspects of the operations of 1605 may be performed by a control signaling component 1125 as described with reference to FIG. 11.

At 1610, the method may include receiving a request to extend the active duration of the cell DRX cycle during one or more cycles of the cell DRX cycle, where transmitting the request is based on a performance parameter associated with an uplink transmission satisfying a threshold. The operations of block 1610 may be performed in accordance with examples as disclosed herein. In some examples, aspects of the operations of 1610 may be performed by a request monitoring component 1130 as described with reference to FIG. 11.

At 1615, the method may include identifying a duration of time that the active duration is to be extended based on receiving the request. The operations of block 1615 may be performed in accordance with examples as disclosed herein. In some examples, aspects of the operations of 1615 may be performed by a duration identification component 1140 as described with reference to FIG. 11.

At 1620, the method may include receiving the uplink transmission during the active duration of a cycle that is extended based on transmitting the request. The operations of block 1620 may be performed in accordance with examples as disclosed herein. In some examples, aspects of the operations of 1620 may be performed by an uplink monitoring component 1135 as described with reference to FIG. 11.

The following provides an overview of aspects of the present disclosure:

Aspect 1: A method for wireless communications, at a UE comprising: receiving control signaling that indicates a cell DRX cycle for a cell communicating with the UE, the cell DRX cycle alternating between an active duration during which the cell is monitoring for communications and an inactive duration during which the cell refrains from monitoring for communications; transmitting a request to extend the active duration of the cell DRX cycle during one or more cycles of the cell DRX cycle, wherein transmitting the request is based at least in part on a performance parameter associated with an uplink transmission satisfying a threshold; and transmitting the uplink transmission during the active duration of a cycle that is extended based at least in part on transmitting the request.

Aspect 2: The method of aspect 1, further comprising: receiving second control signaling that indicates a plurality of cell DRX modes associated with the cell, wherein receiving the control signaling comprises receiving an indication to activate a first cell DRX mode of the plurality of cell DRX modes, wherein the first cell DRX mode includes the DRX cycle.

Aspect 3: The method of any of aspects 1 through 2, wherein transmitting the request comprises: transmitting the request at or before a time that is a duration prior to an end time of a current active duration of the cell DRX cycle.

Aspect 4: The method of aspect 3, wherein the request is a BSR comprising a quantity of non-zero values, and transmitting the request is based at least in part on the quantity of non-zero values satisfying a quantity threshold.

Aspect 5: The method of any of aspects 1 through 4, wherein the request comprises a value associated with a SR codebook, the value being one of: a first value indicating that the cell is to maintain the cell DRX cycle, or a second value indicating that the cell is to extend the active duration.

Aspect 6: The method of any of aspects 1 through 5, further comprising: identifying a duration of time that the active duration is to be extended based at least in part on transmitting the request.

Aspect 7: The method of any of aspects 1 through 6, wherein transmitting the request comprises: transmitting, as part of the request, an indication of a duration of time to extend the active duration.

Aspect 8: The method of aspect 7, wherein the duration of time is based at least in part on a packet size of the uplink transmission, a reference signal receive power condition of a channel associated with the uplink transmission, or both.

Aspect 9: The method of any of aspects 1 through 8, wherein a duration of time the active duration is extended by is semi-statically configured by the cell.

Aspect 10: The method of any of aspects 1 through 9, further comprising: receiving second control signaling enabling the UE to request for extensions of the active duration of the cell DRX cycle based at least in part on a type of data traffic associated with the UE.

Aspect 11: The method of any of aspects 1 through 10, wherein the uplink transmission is a low latency uplink transmission comprising URLLC data or XR data, the performance parameter is a latency parameter and the threshold is a latency threshold.

Aspect 12: The method of any of aspects 1 through 11, further comprising: receiving an acknowledgment message indicating the request to extend the active duration is successfully received, wherein transmitting the uplink transmission is based at least in part on receiving the acknowledgment message.

Aspect 13: The method of any of aspects 1 through 12, wherein the request is one of a SR message, a BSR message, UCI, a MAC-CE, or a PUCCH comprising a NACK.

Aspect 14: A method for wireless communications, at a cell of a network entity, comprising: transmitting control signaling that indicates a cell DRX cycle for the cell communicating with a UE, the cell DRX cycle alternating between an active duration during which the cell is monitoring for communications and an inactive duration during which the cell refrains from monitoring for communications; receiving a request to extend the active duration of the cell DRX cycle during one or more cycles of the cell DRX cycle, wherein transmitting the request is based at least in part on a performance parameter associated with an uplink transmission satisfying a threshold; and receiving the uplink transmission during the active duration of a cycle that is extended based at least in part on transmitting the request.

Aspect 15: The method of aspect 14, further comprising: transmitting second control signaling that indicates a plurality of cell DRX modes associated with the cell, wherein transmitting the control signaling comprises transmitting an indication to activate a first cell DRX mode of the plurality of cell DRX modes, wherein the first cell DRX mode includes the cell DRX cycle.

Aspect 16: The method of any of aspects 14 through 15, wherein receiving the request comprises: receiving the request at or before a time that is a duration prior to an end time of a current active duration of the cell DRX cycle.

Aspect 17: The method of aspect 16, wherein the request is a BSR comprising a quantity of non-zero values, and receiving the request is based at least in part on the quantity of non-zero values satisfying a quantity threshold.

Aspect 18: The method of any of aspects 14 through 17, wherein the request comprises a value associated with a SR codebook, the value being one of: a first value indicating that the cell is to maintain the cell DRX cycle, or a second value indicating that the cell is to extend the active duration.

Aspect 19: The method of any of aspects 14 through 18, further comprising: identifying a duration of time that the active duration is to be extended based at least in part on receiving the request.

Aspect 20: The method of any of aspects 14 through 19, wherein receiving the request comprises: receiving, as part of the request, an indication of a duration of time to extend the active duration.

Aspect 21: The method of aspect 20, wherein the duration of time is based at least in part on a packet size of the uplink transmission, a reference signal receive power condition of a channel associated with the uplink transmission, or both.

Aspect 22: The method of any of aspects 14 through 21, wherein a duration of time the active duration is extended by is semi-statically configured by the cell.

Aspect 23: The method of any of aspects 14 through 22, further comprising: transmitting second control signaling enabling the UE to request for extensions of the active duration of the cell DRX cycle based at least in part on a type of data traffic associated with the UE.

Aspect 24: The method of any of aspects 14 through 23, wherein the uplink transmission is a low latency uplink transmission comprising URLLC data or XR data, the performance parameter is a latency parameter and the threshold is a latency threshold.

Aspect 25: The method of any of aspects 14 through 24, further comprising: transmitting an acknowledgment message indicating the request to extend the active duration is accepted, wherein receiving the uplink transmission is based at least in part on receiving the acknowledgment message.

Aspect 26: The method of any of aspects 14 through 25, wherein the request is one of a SR message, a BSR message, UCI, a MAC-CE, or a PUCCH comprising a NACK.

Aspect 27: The method of any of aspects 14 through 26, further comprising: extending the active duration of the cell DRX cycle by a duration of time for the one or more cycles.

Aspect 28: The method of any of aspects 14 through 27, further comprising: generating an additional active duration relative to a current active duration of the cell DRX cycle for the one or more cycles, wherein a start of the additional active duration is relative to an end of the current active duration.

Aspect 29: A UE for wireless communications, comprising one or more memories storing processor-executable code, and one or more processors coupled with the one or more memories and individually or collectively operable to execute the code to cause the UE to perform a method of any of aspects 1 through 13.

Aspect 30: A UE for wireless communications, comprising at least one means for performing a method of any of aspects 1 through 13.

Aspect 31: A non-transitory computer-readable medium storing code for wireless communications, the code comprising instructions executable by a processor to perform a method of any of aspects 1 through 13.

Aspect 32: A cell of a network entity for wireless communications, comprising one or more memories storing processor-executable code, and one or more processors coupled with the one or more memories and individually or collectively operable to execute the code to cause the cell of a network entity to perform a method of any of aspects 14 through 28.

Aspect 33: A cell of a network entity for wireless communications, comprising at least one means for performing a method of any of aspects 14 through 28.

Aspect 34: A non-transitory computer-readable medium storing code for wireless communications, the code comprising instructions executable by a processor to perform a method of any of aspects 14 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) comprising:
one or more memories storing processor-executable code; and
one or more processors coupled with the one or more memories and individually or collectively operable to execute the code to cause the UE to:
receive control signaling that indicates a cell discontinuous reception (DRX) cycle for a cell communicating with the UE, the cell DRX cycle alternating between an active duration during which the cell is monitoring for communications and an inactive duration during which the cell refrains from monitoring for communications;
transmit a request to extend the active duration of the cell DRX cycle during one or more cycles of the cell DRX cycle, wherein transmitting the request is based at least in part on a performance parameter associated with an uplink transmission satisfying a threshold; and
transmit the uplink transmission during the active duration of a cycle that is extended based at least in part on transmitting the request.

2. The UE of claim 1, wherein the one or more processors are individually or collectively further operable to execute the code to cause the UE to:
receive second control signaling that indicates a plurality of cell DRX modes associated with the cell, wherein receiving the control signaling comprises receiving an indication to activate a first cell DRX mode of the plurality of cell DRX modes, wherein the first cell DRX mode includes the DRX cycle.

3. The UE of claim 1, wherein, to transmit the request, the one or more processors are individually or collectively operable to execute the code to cause the UE to:
transmit the request at or before a time that is a duration prior to an end time of a current active duration of the cell DRX cycle.

4. The UE of claim 3, wherein the request is a buffer status report comprising a quantity of non-zero values, and wherein transmitting the request is based at least in part on the quantity of non-zero values satisfying a quantity threshold.

5. The UE of claim 1, wherein, the request comprises a value associated with a scheduling request codebook, the value being one of:
a first value that indicates for the cell is to maintain the cell DRX cycle, or
a second value that indicates for the cell is to extend the active duration.

6. The UE of claim 1, wherein the one or more processors are individually or collectively further operable to execute the code to cause the UE to:
identify a duration of time that the active duration is to be extended based at least in part on transmitting the request.

7. The UE of claim 1, wherein, to transmit the request, the one or more processors are individually or collectively operable to execute the code to cause the UE to:
transmit, as part of the request, an indication of a duration of time to extend the active duration.

8. The UE of claim 7, wherein the duration of time is based at least in part on a packet size of the uplink transmission, a reference signal receive power condition of a channel associated with the uplink transmission, or both.

9. The UE of claim 1, wherein a duration of time the active duration is extended by is semi-statically configured by the cell.

10. The UE of claim 1, wherein the one or more processors are individually or collectively further operable to execute the code to cause the UE to:
receive second control signaling enabling the UE to request for extensions of the active duration of the cell DRX cycle based at least in part on a type of data traffic associated with the UE.

11. The UE of claim 1, wherein the uplink transmission is a low latency uplink transmission comprising ultra-reliable low latency communication data or extended reality data, the performance parameter is a latency parameter, and the threshold is a latency threshold.

12. The UE of claim 1, wherein the one or more processors are individually or collectively further operable to execute the code to cause the UE to:
receive an acknowledgment message indicating the request to extend the active duration is successfully received, wherein transmitting the uplink transmission is based at least in part on receiving the acknowledgment message.

13. The UE of claim 1, wherein the request is one of a scheduling request message, a buffer status report message, uplink control information, a medium access control-control element, or a physical uplink control channel comprising a negative-acknowledgment.

14. A cell of a network entity, comprising:
one or more memories storing processor-executable code; and
one or more processors coupled with the one or more memories and individually or collectively operable to execute the code to cause the cell to:
transmit control signaling that indicates a cell discontinuous reception (DRX) cycle for the cell communicating with a user equipment (UE), the cell DRX cycle alternating between an active duration during which the cell is monitoring for communications and an inactive duration during which the cell refrains from monitoring for communications;
receive a request to extend the active duration of the cell DRX cycle during one or more cycles of the cell DRX cycle, wherein transmitting the request is based at least in part on a performance parameter associated with an uplink transmission satisfying a threshold; and
receive the uplink transmission during the active duration of a cycle that is extended based at least in part on transmitting the request.

15. The cell of claim 14, wherein the one or more processors are individually or collectively further operable to execute the code to cause the cell to:
transmit second control signaling that indicates a plurality of cell DRX modes associated with the cell, wherein transmitting the control signaling comprises transmitting an indication to activate a first cell DRX mode of the plurality of cell DRX modes, wherein the first cell DRX mode includes the cell DRX cycle.

16. The cell of claim 14, wherein, to receive the request, the one or more processors are individually or collectively operable to execute the code to cause the cell to:
receive the request at or before a time that is a duration prior to an end time of a current active duration of the cell DRX cycle.

17. The cell of claim 16, wherein the request is a buffer status report comprising a quantity of non-zero values, and wherein to receive the request is based at least in part on the quantity of non-zero values satisfying a quantity threshold.

18. The cell of claim 14, wherein the request comprises a value associated with a scheduling request codebook, the value being one of:
a first value that indicates for the cell is to maintain the cell DRX cycle, or
a second value that indicates for the cell is to extend the active duration.

19. The cell of claim 14, wherein the one or more processors are individually or collectively further operable to execute the code to cause the cell to:
identify a duration of time that the active duration is to be extended based at least in part on receiving the request.

20. The cell of claim 14, wherein, to receive the request, the one or more processors are individually or collectively operable to execute the code to cause the cell to:
receive, as part of the request, an indication of a duration of time to extend the active duration.

21. The cell of claim 20, wherein the duration of time is based at least in part on a packet size of the uplink transmission, a reference signal receive power condition of a channel associated with the uplink transmission, or both.

22. The cell of claim 14, wherein a duration of time the active duration is extended by is semi-statically configured by the cell.

23. The cell of claim 14, wherein the one or more processors are individually or collectively further operable to execute the code to cause the cell to:
transmit second control signaling enabling the UE to request for extensions of the active duration of the cell DRX cycle based at least in part on a type of data traffic associated with the UE.

24. The cell of claim 14, wherein the uplink transmission is a low latency uplink transmission comprising ultra-reliable low latency communication data or extended reality data, wherein the performance parameter is a latency parameter, and the threshold is a latency threshold.

25. The cell of claim 14, wherein the one or more processors are individually or collectively further operable to execute the code to cause the cell to:
transmit an acknowledgment message indicating the request to extend the active duration is accepted, wherein receiving the uplink transmission is based at least in part on receiving the acknowledgment message.

26. The cell of claim 14, wherein the request is one of a scheduling request message, a buffer status report message, uplink control information, a medium access control-control element, or a physical uplink control channel comprising a negative-acknowledgment.

27. The cell of claim 14, wherein the one or more processors are individually or collectively further operable to execute the code to cause the cell to:
extend the active duration of the cell DRX cycle by a duration of time for the one or more cycles.

28. The cell of claim 14, wherein the one or more processors are individually or collectively further operable to execute the code to cause the cell to:
generate an additional active duration relative to a current active duration of the cell DRX cycle for the one or more cycles, wherein a start of the additional active duration is relative to an end of the current active duration.

29. A method for wireless communications, at a user equipment (UE) comprising:
receiving control signaling that indicates a cell discontinuous reception (DRX) cycle for a cell communicating with the UE, the cell DRX cycle alternating between an active duration during which the cell is monitoring for communications and an inactive duration during which the cell refrains from monitoring for communications;
transmitting a request to extend the active duration of the cell DRX cycle during one or more cycles of the cell DRX cycle, wherein transmitting the request is based at least in part on a performance parameter associated with an uplink transmission satisfying a threshold; and
transmitting the uplink transmission during the active duration of a cycle that is extended based at least in part on transmitting the request.

30. A method for wireless communications, at a cell of a network entity, comprising:
transmitting control signaling that indicates a cell discontinuous reception (DRX) cycle for the cell communicating with a user equipment (UE), the cell DRX cycle alternating between an active duration during which the cell is monitoring for communications and an inactive duration during which the cell refrains from monitoring for communications;
receiving a request to extend the active duration of the cell DRX cycle during one or more cycles of the cell DRX cycle, wherein transmitting the request is based at least in part on a performance parameter associated with an uplink transmission satisfying a threshold; and
receiving the uplink transmission during the active duration of a cycle that is extended based at least in part on transmitting the request.
